(19) United States
(12) Patent Application Publication
(10) Pub. No.: US 2022/0239523 A1
(43) Pub. Date: Jul. 28, 2022

(54) UNIVERSAL VIRTUAL REMOTE CONTROL FOR SMART DEVICES

(71) Applicant: Avast Software s.r.o., Prague 4 (CZ)

(72) Inventors: Thomas Wespel, Mietingen (DE); Yohamnes Hernandez Baez, Tettnang (DE)

(73) Assignee: Avast Software s.r.o., Prague 4 (CZ)

(21) Appl. No.: 17/649,027

(22) Filed: Jan. 26, 2022

Related U.S. Application Data
(60) Provisional application No. 63/142,244, filed on Jan. 27, 2021.

(51) Int. Cl. H04L 12/28; G06F 3/04847; G06V 20/50; G06F 3/0481; G06F 3/0488

(52) U.S. Cl. CPC H04L 12/2816; G06F 3/04847; G06F 3/0488; G06F 3/0481; G06V 20/50

(57) ABSTRACT

A universal virtual device remote control is implemented on a computerized device such as a smart phone. The remote control operates by receiving one or more pictures of a target device, and identifying the target device by comparing the one or more pictures to pictures in a data set. The remote control also receives functional data associated with the identified device from the data set, and presents controls for the physical device to a user based on the received functional data. An input is received from the user in association with one or more of the controls, and a command associated with the input is sent to the identified device based on the functional data associated with the identified device.

### CROSS-REFERENCE TO RELATED APPLICATIONS

This application claims priority to U.S. Provisional Patent Application Ser. No. 63/142,244, filed on Jan. 27, 2021, entitled “UNIVERSAL VIRTUAL REMOTE CONTROL FOR SMART DEVICES”, currently pending, the entire disclosure of which is incorporated herein by reference.

### FIELD

The invention relates generally to control of networked devices, and more specifically to a universal virtual remote control for smart devices.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

As the Internet grows, the number and variety of devices attached to the Internet have also grown. The Internet of Things (IoT) is a term that evolved to include devices such as smart thermostats, door locks, washers and dryers, home audio/video systems, and other such devices that are not traditional computing devices but that have “smart” functionality that can be controlled or monitored via an Internet connection. For example, home thermostats can be monitored and controlled via a dedicated smart phone app via the Internet, allowing the user to change thermostat settings from remote locations or verify that the home's temperature, humidity, and the like indicate that the home heating, ventilation, and cooling systems are operating as desired. Similarly, an IoT door lock allows notification to the user each time the door is open, as well as custom configuration of passcodes such as limited time access and opening the door remotely on demand such as to let a calling visitor into the house.

Virtual assistants such as Amazon Alexa, Apple Ski, and Google Home further provide for voice control of certain functions, such as where a particular “skill” or capability is loaded into the assistant or made available to the assistant. A user uses a voice command sometimes called a wakeword (such as “Hey Siri”) to initiate interaction with the virtual assistant, then uses a voice command known to the virtual assistant and associated with a skill the virtual assistant knows to complete the command. For example, a user may say “Hey Siri, change the heat to 74 degrees” to cause the virtual assistant to use a skill associated with an Ecobee thermostat to turn the Ecobee thermostat's heat setting to 74 degrees. The knowledge of how the virtual assistant can recognize a spoken instruction to change settings on the Ecobee thermostat, and can in response instruct the Ecobee thermostat to change its heat setting to 74 degrees, is part of a “skill” or configuration package loaded in the user's Siri instance, or is otherwise provided to Ski so that Siri can perform certain actions on certain IoT devices.

But, users are becoming wary of voice-controlled virtual assistants, as many of them listen to a user's words even before a wake word is spoken, and can log or record a user's day-to-day activity and thereby invade the user's privacy. Further, a user must still know the correct spoken commands with a virtual assistant to achieve a desired goal, such that “Hey Siri, turn the heat up two degrees” may work but “Hey Siri, turn the thermostat up two degrees” may not. Knowing the broad range of commands that virtual assistants and Internet of Things devices can recognize and to which they can respond is a daunting task for the average home user, who often simply doesn't use IoT devices to their full potential due to the complexity of interacting with such a wide variety of devices.

For reasons such as these, it is desirable to provide an improved user interface to networked devices such as Internet of Things (IoT) devices.

### SUMMARY

One example embodiment of the invention comprises a universal virtual device remote control, implemented on a computerized device such as a smart phone. The remote control operates by receiving one or more pictures of a target device, and identifying the target device by comparing the one or more pictures to pictures in a database. The remote control also receives functional data associated with the identified device from the database, and presents controls for the physical device to a user based on the received functional data. An input is received from the user in association with one or more of the controls, and a command associated with the input is sent to the identified device based on the functional data associated with the identified device.

In another example, picture identification and/or control and command information regarding the identified device are provided via a remote computerized device, such as a device profile server.

In a further example, the remote control stores the identified device data such as the control and command information regarding the identified device and one or more remote control screen images used to remotely control the identified device, such that a user of the remote control application can select a previously-identified device for use without querying a data set of devices such as by taking a picture of a device that has been previously identified in the user's remote control application.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a computerized virtual universal remote control system, consistent with an example embodiment.

FIG. 2 is a universal remote control screen image, consistent with an example embodiment.

FIG. 3 is a flowchart of a method of operating a universal virtual remote control, consistent with an example embodiment.

FIG. 4 is a computerized virtual remote control system, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made. Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the number of different systems and the complexity of remembering how to control or manage each device can become taxing. The Internet of Things (IoT devices) has evolved such that many common household devices are now computerized and attached to a network such as the Internet, and can be controlled, monitored, and/or configured using commands over a network. For example, smart door locks provide for notification of each entry, as well as configuration of passcodes, fingerprints, and user management via network connections such as smart phone apps or web pages. Devices such as smart thermostats enable not only a high degree of customization of things like temperature hysteresis and secondary devices such as humidifiers, but also provide for data visualization and reporting that were previously unavailable. Smart washers and dryers, refrigerators and stoves, and other home appliances allow operation and/or monitoring from remote locations via a network connection, and new IoT devices are introduced every year.

But, the number of IoT or smart devices being added to homes creates some difficulty for homeowners in that specialized apps are often required to interact with and control the devices, and so various services such as Apple HomeKit and Google Home attempt to manage some of them using a standardized interface. But, the reach of these services is limited to supported classes of devices such as lights, thermostats, and locks, and typically do not provide for adding custom devices to the services provided. Virtual assistants such as Amazon Alexa, Apple Siri, and Google Home also provide voice control of some devices, but again are limited in types of devices supported and can have keywords or commands that are difficult to remember. Further, use of such services often relies upon installing a certain “skill” or functionality set to the virtual assistant so that the assistant recognizes commands that are applicable to a new device, further adding complexity for the user.

Privacy and security are also a concern with some virtual assistants, as users typically use a voice command sometimes called a wakeword (such as “Hey Siri”) to initiate interaction with the virtual assistant before using a voice command known to the virtual assistant and associated with a skill the virtual assistant knows to complete the command. In one example, a user says “Hey Siri, change the heat to 74 degrees” to cause the virtual assistant to use a skill associated with an Ecobee thermostat to turn the Ecobee thermostat's heat setting to 74 degrees. In other examples, the device is always listening and can recognize words and instructions even before a wake word is spoken, raising privacy concerns among home users. Some services are known to store recorded speech for extended times after hearing them spoken, which users generally perceive as not desirable and a breach of privacy in one's home.

Because IoT device control solutions such as loading skills into virtual assistants raise concerns with users and does not address problems such as knowing the correct commands to use for a wide variety of devices, better device control solutions are desired. If a user wishing to control a thermostat can say “Hey Siri, turn the heat up two degrees” but not “Hey Siri, turn the thermostat up two degrees” to achieve the same result, the user must still memorize a complex and exact command language for each device. Knowing the broad range of commands that virtual assistants and Internet of Things devices can recognize and to which they can respond is a daunting task for the average home user, who often simply doesn't use IoT devices to their full potential due to the complexity of interacting with such a wide variety of devices.

Some examples presented herein therefore provide for a universal virtual remote control, implemented via a computerized device such as a smartphone, that allows for easy recognition and configuration of Internet of Things devices and other such devices using device images. In a more detailed example, a user uses a device such as a smart phone running a universal virtual remote control app to take a picture of a device such as an IoT device, and the app recognizes the device such as through a database of known devices. The app retrieves data related to the device to configure and present a remote control, such as a touchscreen display representing the various configuration settings and status information that can be communicated between the device and the remote control app. The user is thereby able to control the device using a touchscreen display on an app, with no user configuration needed other than capturing a recognizable image of the device being controlled. In further examples, device images of various devices added to the remote control app are stored and are used to select a device for control when executing the remote control app.

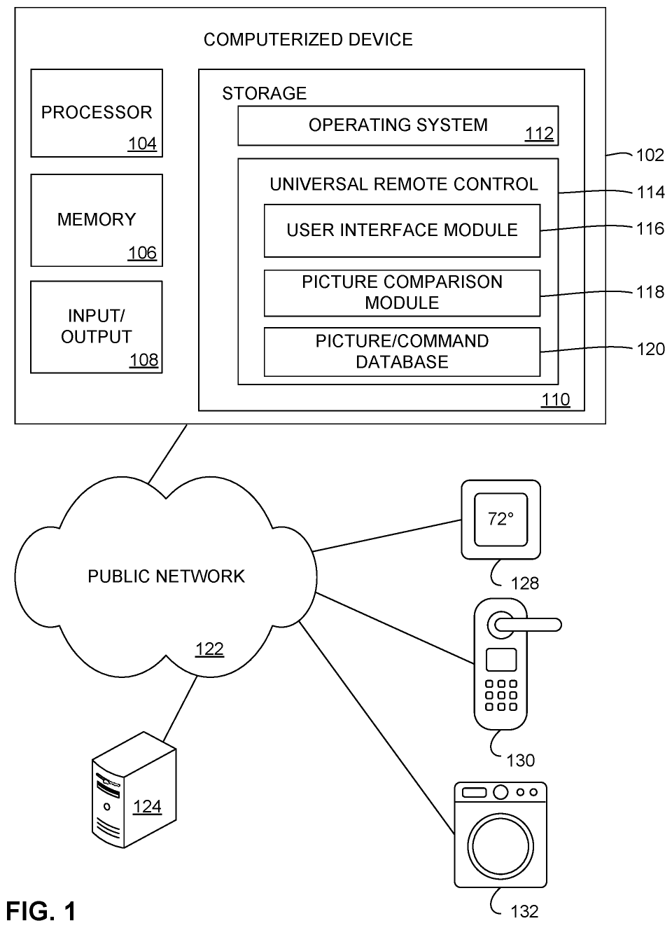

FIG. 1 is a universal virtual remote control, consistent with an example embodiment. Here, a computerized device 102 includes a processor 104 operable to execute computer program instructions and a memory 106 operable to store information such as program instructions and other data while computerized device 102 is operating. The computerized device exchanges electronic data, takes photographs or pictures, receives touch input from a user, and performs other such input/output operations with input/output 108.

Storage 110 stores program instructions including an operating system 112 that provides an interface between software or programs available for execution and the hardware of the computerized smart phone, and manages other functions such as access to input/output devices. The storage 110 also stores program instructions and other data for a universal remote control application (or app) 114, including a user interface module 116, a picture comparison module 118, and a device picture and command database 120.

In this example, the computerized smartphone is also coupled via a public network 122 to one or more remote computers 124, such as remote web or other servers, servers configured to store the picture/command database 120 in alternate embodiments, or remote computers providing other such functions. The computerized device in this example includes at least one camera operable to take digital pictures of physical objects, such as smart thermostat 128, smart door lock 130, and smart appliance 132 (shown here as a washer/dryer).

In operation, a user uses the computerized device, such as a smart phone, as a universal virtual remote control by taking a picture of a device to be controlled (or in alternate embodiments by otherwise identifying the device to be controlled). The picture is used along with a device database to determine the identity of the device and the commands to which the device will respond, and corresponding controls are presented to the user such as via a smartphone app implementing the universal remote control function.

In a more detailed example, the universal remote control 114 executing on computerized device 102 is implemented as an app on a smart phone, and the user initiates interaction with a new device by using a camera 108 comprising a part of the smart phone to take a still picture or photograph, video image, three-dimensional scan, or other picture of the device such as smart thermostat 128, smart door lock 130, or washer/dryer 132. The picture is compared against a database 120 containing images of a variety of known devices, and the device is identified based on the picture. In an alternate embodiment, the database 120 resides in a remote server 124 rather than in the computerized device 102.

Once the device 128-132 is identified using the picture and the database 120, additional information regarding the device is retrieved from database 120 regarding the device, such as what controls or functions can be monitored and/or changed via commands to the device, and what commands can be used to interact with the identified device. This information is used by the universal remote control's user interface module to present a virtual remote control for the device to a user, including icons, symbols, words or abbreviations, or other representations of the controls or functions that can be monitored and/or changed via commands to the device. When a user selects one of the controls, such as by tapping a region of a touchscreen in which an image representing the control is displayed, a corresponding command is sent to the identified device to cause the desired control or function to be implemented.

In a further example, the identified devices are saved in the universal remote control 114's configuration, such that they are available for selection such as by tapping a picture or description of the device when the universal remote control app is running. The universal remote control can thereby serve as a remote control for a wide variety and large number of devices such as 128-132 by using pictures of the devices to identify the devices and load various control and command information for the identified devices to facilitate user interaction with the devices.

In another example, multiple devices matching a picture are presented to a user, such as where a picture of a smart thermostat could be one of any number of similar models of thermostats that look substantially similar such as by sharing the same enclosure but having different capabilities. The user is asked in some such embodiments to select or identify the correct mode from among the matching devices, such as by selecting from a list. In another example, the user is instructed in how to distinguish one model from another having a matching picture before making a selection, such as using a device menu or looking for model markings on the device. In some examples of models with similar appearances, the user need not make a selection but the remote control functions may be limited or may present controls not available for the user's actual device model.

Although the devices presented at 128-132 are typical Internet of Things (IoT) devices, a variety of other devices can also be controlled via the universal remote control in further examples, such as parking meters, ordering items such as food or goods, ride hailing, and the like. In one such example, a user takes a picture of a parking meter that is used to identify the parking jurisdiction and parking spot, and controls are presented to a user enabling selection of a parking term and associated cost. The user makes a selection, and the universal remote control app causes the parking session to be started and in a further example pays for the parking session.

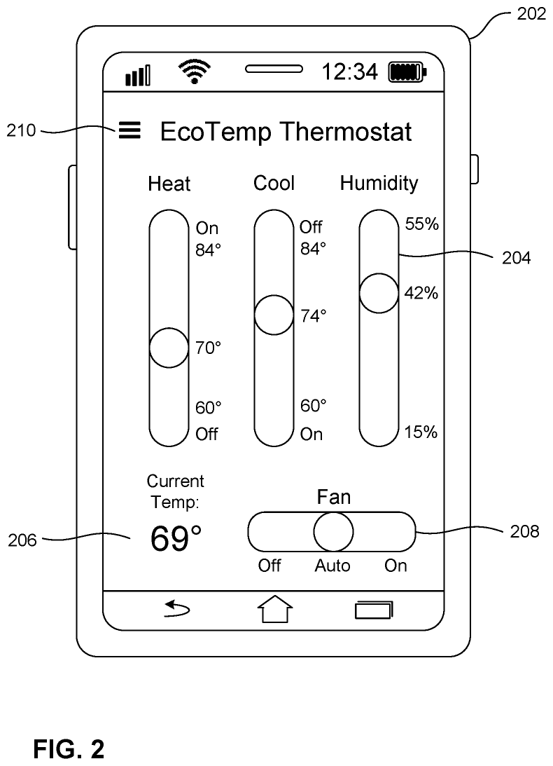

FIG. 2 is a universal remote control screen image, consistent with an example embodiment. Here, the user of a smart phone 202 has executed a universal remote control app, and has taken a picture of a smart thermostat (128 of FIG. 1) to identify the device. In response, the app has searched an image database for matching devices, finding an EcoTemp smart thermostat that matches the provided picture taken with the smart phone. Data regarding the EcoTemp thermostat is then loaded into the app, including both the functions available for the user to control and corresponding commands that can be sent to the smart thermostat to perform various functions.

The screen image shown on the smart phone 202 includes a variety of controls, informational displays, and other information based on the functions available for the EcoTemp thermostat and the commands the EcoTemp thermostat can recognize in this simplified example. The controls the smart thermostat device can receive are heat temperature setting or on/off, cooling temperature setting or on/off, humidity percentage setting, and fan state setting. These controls are represented by the heat, cool, and humidity sliders shown at 204 in the screen image of FIG. 2. Commands that can be sent to the smart thermostat device are temperature on, off, or numeric target state for heat and cooling, humidity target percentage, and fan states of on, off, or auto. Each of the commands are encoded in a format that the smart thermostat can understand, which may be in a format unique to the EcoTemp smart thermostat, as reflected in the information received from the database in response to recognizing the identity of the smart thermostat. Information provided includes current measured temperature as shown at 206.

The user may make adjustments to the smart thermostat using the universal remote control, such as sliding the heat temperature slider shown at 204 up to reflect a target heat temperature of 72° (instead of the current 70° setting), and change the fan setting as shown at 208 to On from its current setting of Auto. Other settings or remote control screens for the EcoTemp thermostat can be selected by tapping the menu icon shown at 210. Upon making each of these changes, corresponding commands in a format recognized by the EcoTemp thermostat are sent to the smart thermostat, causing the state of the device to change corresponding to the new settings. Because both the capabilities of the device and the appropriate command formats for changing the device are stored in a server database associated with the device's identity, identification of the device using a picture or through other means enables the universal remote control app to construct and present a user-friendly remote control screen representing the device's capabilities and to send corresponding commands in a format that the device recognizes.

In a more detailed example, the universal remote control app remote presents graphics such as those of FIG. 2 derived from data types that the device can provide or receive, such as sliders or text entry fields for numeric inputs such as are shown at 206, switches or radio buttons for various state settings as is shown at 208, and displays appropriate to a type of data received such as the numeric current observed temperature shown at 206. The app in some embodiments constructs the virtual remote control screen based on the device capabilities, screen space, and types of data that can be exchanged with the identified device. In a further example, at least some devices (such as the most popular devices) have customized or professionally-created screens representing a useful and attractive layout of the most commonly used device settings. In some examples, users are further able to modify the remote control displays for various devices and save them, such as by choosing the controls and positions of the controls on the screen as shown in FIG. 2, and saving their desired remote control configuration for each device.

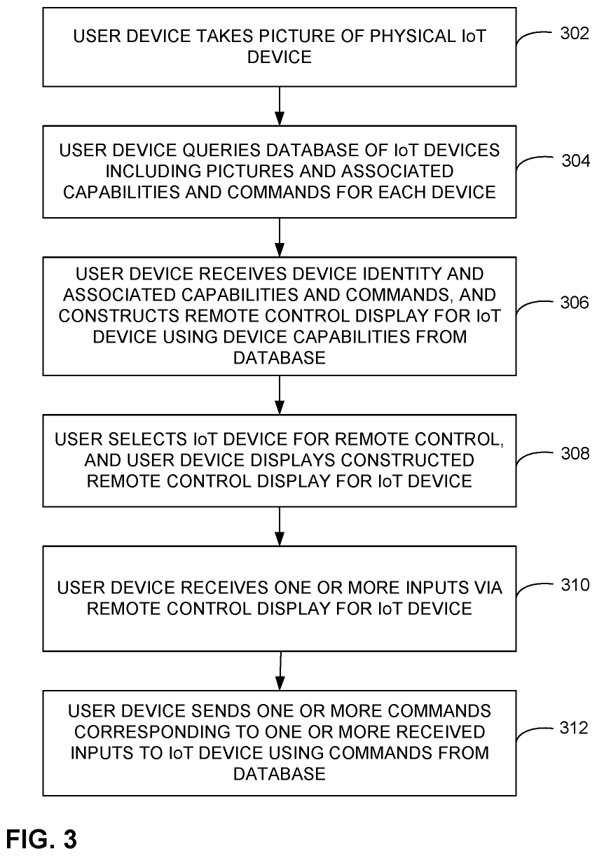

FIG. 3 is a flowchart of a method of operating a universal virtual remote control, consistent with an example embodiment. At 302, a user employs a user device such as a smartphone or tablet executing a universal virtual remote control application to take a picture of a physical IoT device or other device, such as are shown at 128-132 of FIG. 1. The picture in various examples comprises a still photo, a video a three-dimensional scan such as a lidar, or other such representation of the device. The picture is employed at 304 in a query to a database or data set, such as by using an image-matching tool to determine the identity of the device from a data set including a plurality of pictures of known devices. If the device is recognized as a known device, associated commands and capabilities of the identified device are further provided to the user device along with the device's identity, and are used to construct a remote control display for the IoT device at 306. In another example, the data retrieved from the database or data set regarding the IoT device includes remote control displays or other configuration information for presenting a remote control that provides access to the IoT device's capabilities and functions.

The user selects the IoT device for remote control using the universal virtual remote control application at 308, and the application loads a remote control display corresponding to the IoT device's capabilities and functions. The remote control display in some examples is a touchscreen display having various graphical representations of parameters or controls that can be set on the IoT device, and/or other such inputs that can be provided to the device or data that can be received from the device. The display is in various examples constructed from the known parameters or controls of the IoT device, received from the database as a part of the information set regarding the identified IoT device, or otherwise constructed to represent the IoT device's capabilities.

At 310, the user provides one or more inputs to the remote control display (such as is shown in FIG. 2) by touching a control on the screen, entering a text or numeric setting in an input field, or providing another such input. The input is converted to a corresponding command message or signal that the IoT device will recognize based on command information received from the database in conjunction with the identified IoT device, and is sent to the IoT device to implement the user's desired action at 312.

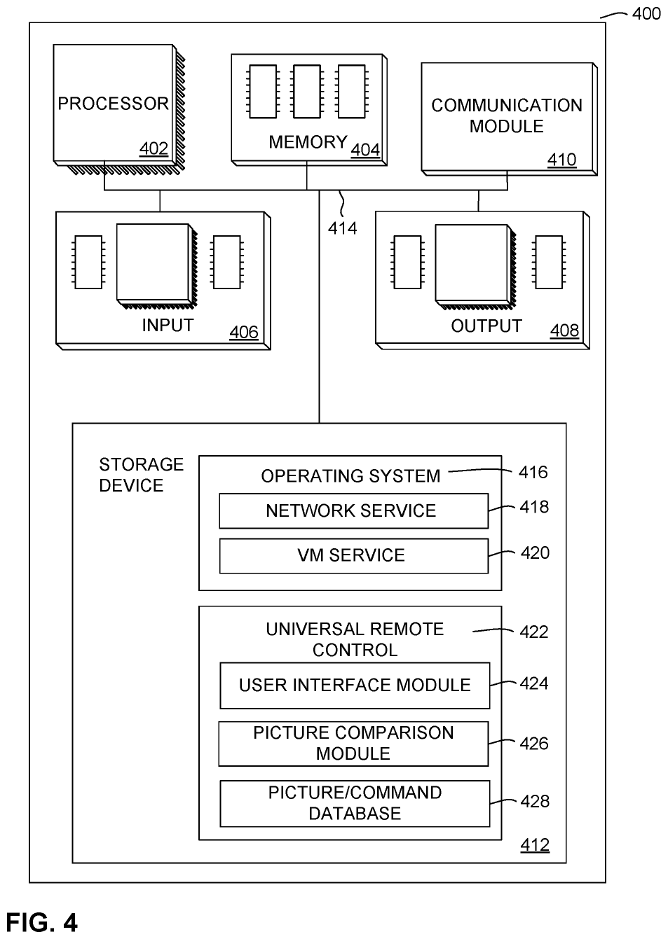

The examples presented herein show how a computerized device such as a smart phone can be used as a universal virtual remote control for IoT and other devices, such as by using a picture of the intended target physical device to identify the device and retrieve device capability and command information from a database of such devices. In some example embodiments, the systems, methods, and techniques described herein are performed on one or more computerized systems having various components such as a camera. Such computerized systems are able in various examples to perform the recited functions such as taking a photograph of a physical device, retrieving device information from a database, displaying a remote control screen representing the device information retrieved from the database enabling interaction with the device, and other such tasks by executing software instructions on a processor, and through use of associated hardware. FIG. 4 is one example of such a computerized universal virtual remote control system. FIG. 4 illustrates only one particular example of computing device 400, and other computing devices 400 may be used in other embodiments. Although computing device 400 is shown as a standalone computing device, computing device 400 may be any component or system that includes one or more processors or another suitable computing environment for executing software instructions in other examples, and need not include all of the elements shown here.

As shown in the specific example of FIG. 4, computing device 400 includes one or more processors 402, memory 404, one or more input devices 406, one or more output devices 408, one or more communication modules 410, and one or more storage devices 412. Computing device 400 in one example further includes an operating system 416 executable by computing device 400. The operating system includes in various examples services such as a network service 418 and a virtual machine service 420 such as a virtual server or virtualized honeypot device. One or more applications, such universal remote control application 422 are also stored on storage device 412, and are executable by computing device 400.

Each of components 402, 404, 406, 408, 410, and 412 may be interconnected (physically, communicatively, and/or operatively) for inter-component communications, such as via one or more communications channels 414. In some examples, communication channels 414 include a system bus, network connection, inter-processor communication network, or any other channel for communicating data. Applications such universal remote control application 422 and operating system 416 may also communicate information with one another as well as with other components in computing device 400.

Processors 402, in one example, are configured to implement functionality and/or process instructions for execution within computing device 400. For example, processors 402 may be capable of processing instructions stored in storage device 412 or memory 404. Examples of processors 402 include any one or more of a microprocessor, a controller, a digital signal processor (DSP), an application specific integrated circuit (ASIC), a field-programmable gate array (FPGA), or similar discrete or integrated logic circuitry.

One or more storage devices 412 may be configured to store information within computing device 400 during operation. Storage device 412, in some examples, is known as a computer-readable storage medium. In some examples, storage device 412 comprises temporary memory, meaning that a primary purpose of storage device 412 is not long-term storage. Storage device 412 in some examples is a volatile memory, meaning that storage device 412 does not maintain stored contents when computing device 400 is turned off. In other examples, data is loaded from storage device 412 into memory 404 during operation. Examples of volatile memories include random access memories (RAM), dynamic random access memories (DRAM), static random access memories (SRAM), and other forms of volatile memories known in the art. In some examples, storage device 412 is used to store program instructions for execution by processors 402. Storage device 412 and memory 404, in various examples, are used by software or applications running on computing device 400 such as universal remote control application 422 to temporarily store information during program execution.

Storage device 412, in some examples, includes one or more computer-readable storage media that may be configured to store larger amounts of information than volatile memory. Storage device 412 may further be configured for long-term storage of information. In some examples, storage devices 412 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 400, in some examples, also includes one or more communication modules 410. Computing device 400 in one example uses communication module 410 to communicate with external devices via one or more networks, such as one or more wireless networks. Communication module 410 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 400 uses communication module 410 to wirelessly communicate with an external device such as via public network 122 of FIG. 1.

Computing device 400 also includes in one example one or more input devices 406. Input device 406, in some examples, is configured to receive input from a user through tactile, audio, or video input. Examples of input device 406 include a touchscreen display, a mouse, a keyboard, a voice-responsive system, a video camera, a microphone, or any other type of device for detecting input from a user.

One or more output devices 408 may also be included in computing device 400. Output device 408, in some examples, is configured to provide output to a user using tactile, audio, or video stimuli. Output device 408, in one example, includes a display, a sound card, a video graphics adapter card, or any other type of device for converting a signal into an appropriate form understandable to humans or machines. Additional examples of output device 408 include a speaker, a light-emitting diode (LED) display, a liquid crystal display (LCD), or any other type of device that can generate output to a user.

Computing device 400 may include operating system 416. Operating system 416, in some examples, controls the operation of components of computing device 400, and provides an interface from various applications such as universal remote control application 422 to components of computing device 400. For example, operating system 416, in one example, facilitates the communication of various applications such as universal remote control application 422 with processors 402, communication unit 410, storage device 412, input device 406, and output device 408. Applications such as universal remote control application 422 may include program instructions and/or data that are executable by computing device 400. As one example, universal remote control application 422 uses user interface module 424 to receive images of IoT devices and other devices to identify the devices via picture comparison module 426 and picture/command database 428. Commands from the database 428 are also employed in the user interface module 424 to implement a remote control for identified devices such as by presenting a touchscreen representation of a remote control for the device to a user that is operable to receive inputs from the user and in response send commands corresponding to the inputs to the identified device. These and other program instructions or modules may include instructions that cause computing device 400 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of providing a universal virtual device remote control via a computerized system, comprising:
receiving one or more pictures of a physical device to identify the physical device;
receiving functional data associated with the identified physical device;
presenting one or more controls for the physical device to a user based on the received functional data associated with the physical device via a display;
receiving an input from the user in association with one or more of the controls; and
sending a command to the physical device, the command associated with the one or more controls associated with the received input and based on the functional data associated with the identified physical device.

2. The method of providing a universal virtual networked device remote control of claim 1, wherein the one or more pictures comprise digital pictures taken via a camera comprising a part of the computerized system.

3. The method of providing a universal virtual networked device remote control of claim 1, further comprising identifying the physical device via the one or more pictures of the physical device.

4. The method of providing a universal virtual networked device remote control of claim 1, wherein the one or more pictures comprise still photos, video, or three-dimensional scans.

5. The method of providing a universal virtual networked device remote control of claim 1, wherein the received functional data is received from a server storing functional data associated with one or more physical devices and/or physical device images.

6. The method of providing a universal virtual networked device remote control of claim 1, wherein the received functional data is received from a local database associated with one or more physical devices and/or physical device images.

7. The method of providing a universal virtual networked device remote control of claim 1, wherein the functional data comprises one or more available controls of the physical device and associated commands to which the physical device responds.

8. The method of providing a universal virtual networked device remote control of claim 1, wherein presenting one or more controls comprises presenting the one or more controls via a touchscreen display, and receiving input comprises receiving the input via the touchscreen display.

9. The method of providing a universal virtual networked device remote control of claim 1, wherein sending a command to the physical device based on functional data comprises sending a command in a format identified in the received functional data associated with the identified physical device.

10. The method of providing a universal virtual networked device remote control of claim 1, further comprising creating a selectable avatar for the physical device using an image of the device such that selecting the avatar provides access to the one or more presented controls.

11. A universal virtual networked device remote control, comprising:
a processor and a memory; and
a remote control software module executable on the processor when loaded into memory, the remote control module operable when executed to:
receive one or more pictures of a physical device to identify the physical device;
receive functional data associated with the identified physical device;
present one or more controls for the physical device to a user based on the received functional data associated with the physical device via a display;
receive an input from the user in association with one or more of the controls; and
send a command to the physical device, the command associated with the one or more controls associated with the received input and based on the functional data associated with the identified physical device.

12. The universal virtual networked device remote control of claim 11, wherein the one or more pictures comprise digital pictures taken via a camera comprising a part of the remote control.

13. The universal virtual networked device remote control of claim 11, the remote control module further operable when executed to identify the physical device via the one or more pictures of the physical device.

14. The universal virtual networked device remote control of claim 11, wherein the one or more pictures comprise still photos, video, or three-dimensional scans.

15. The universal virtual networked device remote control of claim 11, wherein the received functional data is received from a server storing functional data associated with one or more physical devices and/or physical device images.

16. The universal virtual networked device remote control of claim 11, wherein the received functional data is received from a database local to the remote control device and is associated with one or more physical devices and/or physical device images.

17. The universal virtual networked device remote control of claim 11, wherein the functional data comprises one or more available controls of the physical device and associated commands to which the physical device responds.

18. The universal virtual networked device remote control of claim 11, wherein presenting one or more controls comprises presenting the one or more controls via a touchscreen display, and receiving input comprises receiving the input via the touchscreen display.

19. The universal virtual networked device remote control of claim 11, wherein sending a command to the physical device based on functional data comprises sending a command in a format identified in the received functional data associated with the identified physical device.

20. The universal virtual networked device remote control of claim 11, the remote control module further operable when executed to create a selectable avatar for the physical device using an image of the device such that selecting the avatar provides access to the one or more presented controls.
